(19) United States
(12) Patent Application Publication
(10) Pub. No.: US 2005/0249659 A1
(43) Pub. Date: Nov. 10, 2005

(54) Scour media for titanium dioxide production

(76) Inventors: Harry Eugene Flynn, Edmond, OK (US); Joe Bert Maker, Guthrie, OK (US); Trent Roger Keller, Brighton, CO (US)

Correspondence Address: LAW OFFICE OF STANLEY K. HILL, PLC, P.O. BOX 52050, MINNEAPOLIS, MN, 55402, US

(21) Appl. No.: 10/838,914

(22) Filed: May 4, 2004

(51) Int. Cl. B08B 7/00; C01G 23/047

(52) U.S. Cl. 423/610; 134/6

(57) ABSTRACT

Anatase titanium dioxide pigment calcined to a crush strength and density meeting the requirements for an acceptable scour medium is effectively utilized as a scour medium in the chloride process for producing rutile titanium dioxide. The calcining process converts a portion of the anatase pigment to rutile. This calcined anatase can, consequently, be utilized as a scour medium in the chloride process for producing rutile titanium dioxide. The calcined anatase is not a contaminant to the process for producing rutile titanium dioxide. Thus, relatively inexpensive anatase can be converted into a rutile scour medium that can be processed into pigment.

### FIELD OF THE INVENTION

The present invention generally relates to the production of rutile titanium dioxide. More specifically, the present invention relates to the use of calcined anatase as scour media for the production of rutile titanium dioxide.

### BACKGROUND AND SUMMARY OF THE INVENTION

In the chloride process for making titanium dioxide, titanium tetrachloride is oxidized in the vapor phase, in an oxidation reactor, to form rutile titanium dioxide. The titanium dioxide and other reaction products typically are then passed through an externally cooled conduit where they are cooled and coalesced. The titanium dioxide particles primarily form in the gas phase, but due to forces such as thermophoresis and turbulence, the titanium dioxide particles can be swept to the walls of the reactor. Once the particles reach the wall they tend to adhere and build up. Similarly, solid deposits can adhere and build up on the internal walls of the cooling conduit. The buildup of titanium dioxide particles reduces the heat transfer from the process, which causes cooling problems. Moreover, this buildup can eventually plug up the equipment, stopping the flow entirely and necessitating a shutdown for cleaning.

In order to prevent the deposition and buildup of titanium dioxide, various scour media are typically introduced into the oxidation reactor or the cooling conduit. The purpose of the scour media is to behave as scrubbing material and keep the walls of the reactor and cooling conduit free of titanium dioxide deposits without causing noticeable material abrasion on the internal surfaces. Thus, desirable scour media are hard enough to scour the walls of a reactor, but not so hard or abrasive such that the media wear away the walls of the oxidation reactor or the cooling conduit. Various types of material have been used as scour media, such as compressed titanium dioxide pigment, mixtures of titanium dioxide and water which are pelletized, sand, aluminum oxide, zirconium oxide, and salts, for example. Preferable scour media will be sufficiently inexpensive and sufficiently compatible with the produced pigment (that is, titanium dioxide) such that the scour media need not be separated from the product. For example, when salt is used as a scour medium, it is typically dissolved and washed away. Other scour media, such as sand, must be separated from the pigment stream due to the media's value or tendency to contaminate the pigment.

It has been discovered that calcining anatase pigment to a crush strength and density meeting the requirements for an acceptable scour medium converts a portion of the anatase pigment to rutile. This calcined anatase can, consequently, be utilized as a scour medium in the chloride process for producing rutile titanium dioxide. Moreover, the calcined anatase is not a contaminant to the process for producing rutile titanium dioxide. Thus, it has been discovered that relatively inexpensive anatase can be converted into a rutile scour medium that can be processed into pigment.

### DETAILED DESCRIPTION OF PREFERRED EMBODIMENTS OF THE INVENTION

In the following detailed description of preferred embodiments of the present invention, reference is made to specific embodiments in which the present invention may be practiced. It should be understood that other embodiments may be utilized and changes may be made without departing from the scope of the present invention.

Anatase and rutile are the most common of the seven or more titanium dioxide polymorphs. Both anatase and rutile have been reported in nature. Additionally, the chloride process for manufacturing titanium dioxide is well known and is described in detail in numerous patents, including U.S. Pat. Nos. 2,488,439; 2,488,440; 2,559,638; and 2,833,627. Different types of scour media used in the chloride process are likewise described in numerous patents, including U.S. Pat. Nos. 2,721,626; 2,899,278; 4,784,841; and 5,266,108.

The present invention concerns the discovery that anatase titanium dioxide can be calcined to provide a suitable scour medium in the chloride process for producing rutile titanium dioxide. Preferably, to be used as a scour medium according to the present invention the calcined anatase will have a density of at least about 1.55 g/cm³ and no more than about 1.71 g/cm³. Further, calcined anatase useful as scour media in accordance with the present invention will preferably have a crush strength of less than about 30 and a crush strength greater than about 15, where the indicated crush strength is measured using a 4K Crush test (that is, API RP60).

It has been discovered in particular that when anatase titanium dioxide is calcined to a sufficient hardness and density to be utilized as a scour medium, a portion of the anatase is converted to rutile. Because of this, the product of the calcining process can be used as a scour medium in the chloride process for the production of rutile titanium dioxide, generally without having to be recovered from the final product.

Table 1 shows the density, crush strength, and percent anatase of anatase samples calcined at different temperatures. As illustrated in Table 1, the anatase sample calcined at a temperature of 1000° C. (that is, Sample 1) had a crush strength of 47.09 and was therefore too soft (higher numbers in the 4K Crust test are softer) to use effectively as a scour medium in a chloride process for producing rutile titanium dioxide. The anatase sample calcined at 1025° C. (that is, Sample 2) had a crush strength of 29.9 (that is, within the preferred range of 15-30).

In Sample 2, approximately 15 percent of the anatase was converted to rutile. The amount of anatase that can be tolerated in the final product, without having to be recovered from the final product, will depend on the application for which the final product is to be used. Preferably, the final product will contain no more than about 2 percent by weight of anatase. More preferably, the final product will contain no more than about 1 percent by weight of anatase. Typically, the scour medium will comprise no more than about 5percent of the total solids (that is, pigment) flow through the chloride process for producing rutile titanium dioxide and no more than about 2 percent of the total mass flow. The total amount of scour medium used in accordance with the present invention is from about 2.5 percent to about 5 percent of the total pigment flow through the process. Thus, if the amount of scour media through the process is about 2.5 percent of the total pigment flow and the final product should contain no more than about 2 percent of anatase, then the acceptable amount of anatase in the scour medium will be about 80 percent. Sample 2 comprises about 85 percent anatase, which is close to the upper range of the acceptable amount of anatase.

Calcining at higher temperatures produced samples having lower crush strength (that is, harder pigment) and having lower percentages of unconverted anatase. For example, Sample 3, calcined at 1075° C., had a crush strength of 7.44 and comprised about 5.7 percent anatase and about 94.3 percent rutile. Although the crush strength of Sample 3 is below the preferred range of 15-30, it may nonetheless be useful in certain applications. Calcining the anatase at even higher temperatures (Samples 4-6, for example) produces scour media with a crush strength slightly below the preferred range and with substantially all of the anatase being converted to rutile.

TABLE 1

| Sample No. | 1 | 2 | 3 | 4 | 5 | 6 |
|---|---|---|---|---|---|---|
| Temperature | 1000° C. | 1025° C. | 1075° C. | 1125° C. | 1150° C. | 1300° C. |
| Bulk Density | 1.39 | 1.61 | 1.74 | 1.7 | 1.72 | 1.94 |
| (g/cm³) | | | | | | |
| 4K Crush | 47.09 | 29.9 | 7.44 | 7.62 | 10.35 | 5.21 |
| % Anatase | | 85 | 5.7 | 0 | 0 | 0 |
| % Rutile | | 15 | 94.3 | 100 | 100 | 100 |

Those skilled in the art of manufacturing titanium dioxide pigment by a sulfate process are well-acquainted with the calcination of anatase titanium dioxide. For example, calcined anatase useful as scour media in accordance with the present invention can be produced by starting with finished anatase pigment and agglomerating the pigment with water to form pellets. The pellets are then dried and screened to remove pellet sizes that are undesirably too large or undesirably too small. The pellets are then calcined in a rotary calciner at the determined temperature for an amount of time (that is, the residence time) sufficient to calcine the anatase. The temperature and residence time for calcining may vary slightly depending on the grade of anatase pigment used. For example, the types and amounts of additives to the anatase pigment may affect the temperature or residence time needed for calcining. However, the desired calcining temperature and residence time can be determined for a given source of anatase pigment without undue experimentation.

Alternately, calciner discharge from an anatase production process can be used as the source for further calcining according to the present invention. The discharge can be screened to remove material not of appropriate size and can then be further calcined to produce scour media in accordance with the present invention. Again, the temperature and residence time needed may vary depending on the source of anatase, but can be determined without undue experimentation.

The calcined anatase can be used as scour media by introducing the scour medium into the process for production of rutile titanium dioxide. Methods for introducing scour media are known in the art. For example, scour media according to the present invention can be introduced into an oxidation reactor used in the chloride process for producing rutile titanium dioxide. Alternately, scour media according to the present invention can be introduced into cooling conduits used in the chloride process for producing rutile titanium dioxide.

The present invention provides for scour media that can be effectively utilized in the chloride process for production of rutile titanium dioxide without having to be separated or recovered from the final product. While the present invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and by equivalents thereto.

1-14. (canceled)

15. A method for producing rutile titanium dioxide, comprising the steps of:
calcining anatase titanium dioxide to a crush strength of less than about 30; and
introducing the calcined anatase into equipment for the production of rutile titanium dioxide.

16. A method according to claim 15, wherein the equipment is for the production of rutile titanium dioxide via the chloride process.

17. A method according to claim 15, wherein the anatase is calcined to a crush strength of greater than about 15.

18. A method for producing rutile titanium dioxide, comprising the steps of:
obtaining anatase titanium dioxide from an anatase production process;
calcining the anatase titanium dioxide to a crush strength of less than about 30; and
introducing the calcined anatase into equipment for the production of rutile titanium dioxide.

19. A method according to claim 18, wherein the anatase production process is a sulfate process for the production of anatase titanium dioxide.

20. A method according to claim 18, wherein the obtained anatase is obtained from calciner discharge from an anatase production process.

21. A method according to claim 18, wherein the anatase is calcined to a crush strength greater than about 15.

22. A method for producing rutile titanium dioxide, comprising the steps of:
obtaining anatase titanium dioxide from a sulfate process for the production of anatase titanium dioxide calcining the anatase titanium dioxide to a crush strength of less than about 30 and greater than about 15; and
introducing the calcined anatase into equipment for the production of rutile titanium dioxide via the chloride process.

23. A method for producing rutile titanium dioxide, comprising the steps of:
obtaining anatase titanium dioxide from a sulfate process for the production of anatase titanium dioxide calcining the anatase titanium dioxide to a crush strength of less than about 30 and greater than about 15;
introducing the calcined anatase into equipment for the production of rutile titanium dioxide via the chloride process; and
producing titanium dioxide containing no more than about 2 percent by weight of anatase.

24. A method according to claim 23, wherein the producing step produces titanium dioxide containing no more than about 1percent by weight of anatase.

25. A method according to claim 23, wherein the introduced calcined anatase comprises no more than about 5 percent of the produced titanium dioxide.

26. A method according to claim 23, wherein the introduced calcined anatase comprises no less than about 2.5 percent of the produced titanium dioxide.

27. A method according to claim 15, wherein the calcining step takes place at a temperature greater than about 1025° C.

28. A method according to claim 15, wherein the calcining step takes place at a temperature from about 1025° C. to about 1075° C.

29. A method according to claim 15, wherein the anatase is calcined to a density of from about 1.55 g/cm³ to about 1.71 g/cm³.

30. A method according to claim 15, wherein the calcined anatase is introduced into an oxidation reactor.

31. A method according to claim 15, wherein the calcined anatase is introduced into a cooling conduit.

32. A method according to claim 22, wherein the calcining step takes place at a temperature greater than about 1025° C.

33. A method according to claim 22, wherein the calcining step takes place at a temperature from about 1025° C. to about 1075° C.

34. A method according to claim 22, wherein the anatase is calcined to a density of from about 1.55g/cm³ to about 1.71g/cm³.

35. A method according to claim 22, wherein the calcined anatase is introduced into an oxidation reactor.

36. A method according to claim 22, wherein the calcined anatase is introduced into a cooling conduit.
